(19) United States
(12) Patent Application Publication
(10) Pub. No.: US 2025/0221532 A1
(43) Pub. Date: Jul. 10, 2025

(54) Multi-Function Artist's Support

(71) Applicant: James Wilcox, Jackson, WY (US)

(72) Inventor: James Wilcox, Jackson, WY (US)

(21) Appl. No.: 19/011,552

(22) Filed: Jan. 6, 2025

Related U.S. Application Data
(60) Provisional application No. 63/618,312, filed on Jan. 6, 2024.

(51) Int. Cl. A47B 97/08; F16M 11/34; G03B 17/56

(52) U.S. Cl. CPC A47B 97/08; F16M 11/34; G03B 17/561; F16M 2200/024

(57) ABSTRACT

An artist's support includes a base, a support arm, pivotally attached to and upwardly extending from the base, and a group of legs, pivotally connected to and downwardly extending from the base. The base includes a multi-purpose adapter, configured to receive and mechanically secure an artist's device. The legs have a folded position, in which the legs are generally parallel and proximal to each other, and an unfolded position in which the legs are angularly spread apart. Each leg includes a plurality of telescoping tubes connected via an internal one-way cam lock device. A release mechanism is disposed at an upper end of each leg, configured to selectively (a) release the cam lock device to allow sliding linear retraction of the respective leg, and (b) allow angular extension of the respective leg.

### PRIORITY CLAIM

The present application claims priority from U.S. Provisional Patent Application Ser. No. 63/618,312, filed Jan. 6, 2024 and entitled COMBINATION BOX EASEL AND CAMERA TRIPOD.

### BACKGROUND

### Field of the Invention

The present application relates generally to support devices for artists similar to tripods and easels. More particularly, the present application discloses a multi-function support that can be used by photographers and artists as a combination box easel and camera tripod.

### Related Art

A box easel combines a sketchbox, an easel, and a canvas carrier in a single collapsible package that is relatively easy to transport. The sketchbox is supported on collapsible legs, and is typically configured to hold a palette, paint, brushes, pencils, watercolors, pastels and other art supplies that the artist may desire to use. Extending upward from the sketchbox is an arm for supporting the artist's canvas or other media. Advantageously, both the legs and the canvas arm are foldable or collapsible onto the sketchbox, so that the entire device folds up into a single, relatively compact package for ease of travel. Because of their transportability, box easels are popular with artists who paint outdoors or travel to specific locations to work, rather than merely work in a studio.

One challenge associated with box easels is their overall size. It is generally desirable that the box easel be as small and easily portable as possible, while still providing adequate facilities for the artist's use.

Additionally, many artists are also involved in photography, either as a separate artistic pursuit, or as an adjunct to their painting, such as to capture specific lighting or other temporary conditions of a scene for later reference. However, when traveling to a site to work, if the artist desires to take high quality photographs in addition to painting, he must generally bring a separate tripod for the camera. This increases the quantity of equipment that must be obtained and transported to the work site, which can add cost, complexity and additional burdens to the work.

### SUMMARY

It has been recognized that it would be advantageous to develop an artist's support structure that is small, lightweight and easily portable, while also being rugged and adjustable in a variety of ways.

It has also been recognized that it would be advantageous to have an artist's support structure that is easily convertible for use in painting, photography and other artistic pursuits.

In accordance with one embodiment thereof, the present invention provides an artist's support, having a base, a support arm pivotally attached to and upwardly extending from the base, and a plurality of telescoping tubular legs, downwardly extending from the base. A one-way ratchet mechanism pivotally interconnects a top of each leg to the base, and is configured to freely allow angular folding and resist angular extension of the respective leg. A one-way cam lock device is disposed within each tubular leg, and configured to allow free sliding linear extension and resist linear compression of the respective leg. A multi-function release mechanism is associated with each leg, having a biased release actuator, coupled to the ratchet mechanism and the internal cam lock device. The release actuator has a first release position that releases the cam lock device, allowing telescoping linear retraction of the leg without affecting the ratchet mechanism, and a second release position that releases both the cam lock device and the ratchet mechanism.

In accordance with another aspect thereof, the invention provides a combination box easel and camera support, having a base, a support arm, pivotally attached to and upwardly extending from the base, and a group of legs, pivotally connected to and downwardly extending from the base. The base includes a multi-purpose adapter, configured to receive and mechanically secure an artist's device. The legs have a folded position, in which the legs are generally parallel and proximal to each other, and an unfolded position in which the legs are angularly spread apart. Each leg includes a plurality of telescoping tubes connected via an internal one-way cam lock device. A release mechanism is disposed at an upper end of each leg, configured to selectively (a) release the cam lock device to allow sliding linear retraction of the respective leg, and (b) allow angular extension of the respective leg.

In accordance with yet another aspect thereof, the invention provides a combination box easel and camera tripod having a base, a support arm, pivotally attached to and upwardly extending from the base, and three telescoping legs, each leg pivotally connected to the base on a pivot shaft and extending downward therefrom. Each telescoping leg has upper and lower telescoping sections, with a one-way cam-lock device, interconnecting the upper and lower telescoping sections of each leg. The cam-lock device has a first condition in which the upper and lower sections are locked against compression of the leg while being freely slidingly extendable, and a released condition, allowing both sliding extension and retraction of the leg. A one-way ratchet mechanism is interconnected between the base and a top end of each leg, configured to selectively lock a rotational angle of the leg against angular extension while freely allowing selective folding angular retraction of the leg. A release actuator is disposed upon each leg, mechanically engaged with the cam lock device and the ratchet mechanism of the respective leg, the release actuator having a partial release position in which only the cam lock device is released, and a full release position in which both the cam lock device and the ratchet mechanism are released.

### BRIEF DESCRIPTION OF THE DRAWINGS

Various features and advantages of the invention will be apparent from the detailed description which follows, taken in conjunction with the accompanying drawings, which together illustrate, by way of example, features of the invention, and wherein:

FIG. 1 is a perspective view of an embodiment of an artist's support structure in accordance with the present disclosure in its unfolded operational configuration;

FIG. 2 is a perspective view of the artist's support structure of FIG. 1 in its folded configuration;

FIG. 3 is a front view of the artist's support structure of FIG. 5 showing the manner of opening of the artist's box;

FIG. 4 is side view of the artist's support structure of FIG. 1 with the artist's box attached;

FIG. 5 is a close-up top view of the base of the artist's support structure of FIG. 1

FIG. 6 is a top perspective view of the artist's support structure of FIG. 1 in its operational configuration with a user attaching an artist's box top the base;

FIG. 7 is a close-up side view of the base of the artist's support structure of FIG. 1, showing the connection of the upright support;

FIG. 8 is a side perspective view of the base of the artist's support structure of FIG. 1, having a camera connected to the upright support;

FIG. 9 is a front view of a one-piece embodiment of an artist's support structure in accordance with the present disclosure, in a folded configuration, having hingedly attached artist's trays;

FIG. 10 is a side view of the artist's support structure of FIG. 9 with having only one artist's tray attached to the base, with that one tray extended;

FIG. 11A is close-up partial front cross-sectional view of the base showing the leg folding mechanism in the folded and locked configuration with the release levers fully depressed;

FIG. 11B is close-up partial front cross-sectional view of the base and leg folding mechanism with the release levers fully depressed and the legs in a fully released position;

FIG. 11C is close-up partial front cross-sectional view of the base showing the leg folding mechanism locked in a first angular position with the release levers fully extended;

FIG. 11D is close-up partial front cross-sectional view of the base showing the leg folding mechanism locked in a second angular position with the release levers fully extended;

FIG. 11E is close-up partial front cross-sectional view of the base and leg folding mechanism showing the release levers partially depressed to allow retraction of the telescoping legs while the legs are locked in a particular angular position;

FIG. 12A is a close-up view of the ratchet gear and the release lever and pawl of the base and leg folding mechanism of FIGS. 11A-E, with the release lever fully extended and the pawl engaged with the ratchet gear;

FIG. 12B is a close-up of the release lever and pawl of the base and leg folding mechanism of FIGS. 11A-E, with the release lever partially released while the pawl is engaged with the ratchet gear;

FIG. 12C is a close-up of the release lever and pawl of the base and leg folding mechanism of FIGS. 11A-E, with the release lever fully released and the pawl withdrawn from the ratchet gear;

FIG. 13 is a close-up partial front cross-sectional view of another embodiment of the base and leg folding mechanism in which the release actuator is a slide;

FIG. 14 is a close-up side cross-sectional view of the embodiment of FIG. 12, showing the cam lock mechanism of the rear leg of the slide actuator embodiment;

FIG. 15A is a cross-sectional view of a telescoping leg in an extended position, with two cam locking devices locked;

FIG. 15B is a cross-sectional view of the telescoping leg of FIG. 14A in a fully linearly retracted position, with both of the cam locking devices unlocked; and

FIG. 16 is a close-up cross-sectional view of an internal tube cam locking device for use in the telescoping legs of an artist's support structure in accordance with the present disclosure.

### DETAILED DESCRIPTION

Reference will now be made to exemplary embodiments illustrated in the drawings, photos and other figures, and specific language will be used herein to describe the same. It will nevertheless be understood that no limitation of the scope of the invention is thereby intended. Alterations and further modifications of the inventive features illustrated herein, and additional applications of the principles of the inventions as illustrated herein, which would occur to one skilled in the relevant art and having possession of this disclosure, are to be considered within the scope of the invention.

As noted above, some box easel and tripod systems that are known can be large, bulky, heavy, and difficult to use. Advantageously, the inventor has developed a combination box easel and tripod device that is lighter, simpler to use and more versatile than many other similar devices that are known. The device provides a combination artist's easel, box easel or photo tripod that can also have other boxes or equipment attached, such as a camera, a telescope, etc. It offers great versatility, ease and speed of setup and takedown in an extremely compact package. The device can be referred to more generally as an artist's support structure, and this term and the term box easel and tripod are used interchangeably herein.

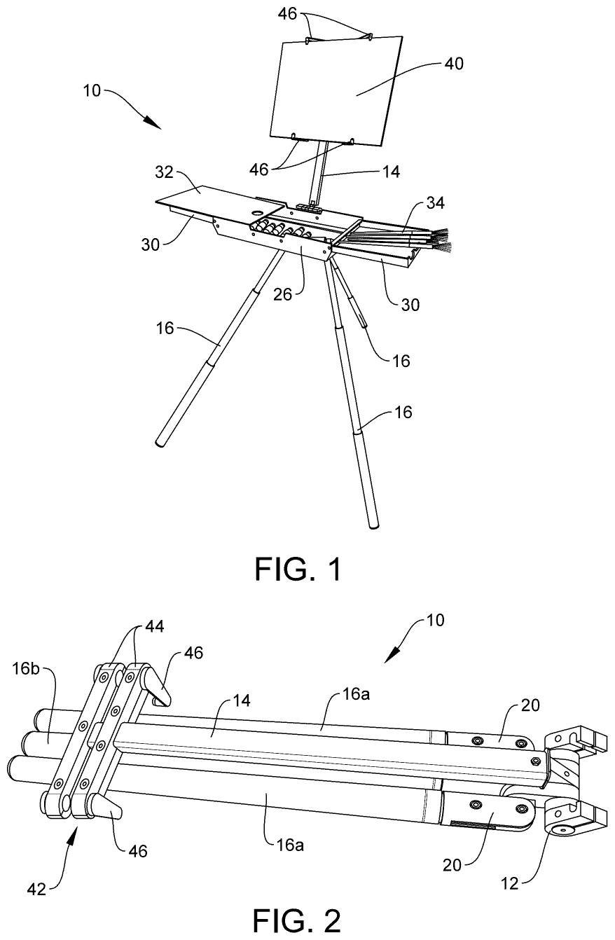

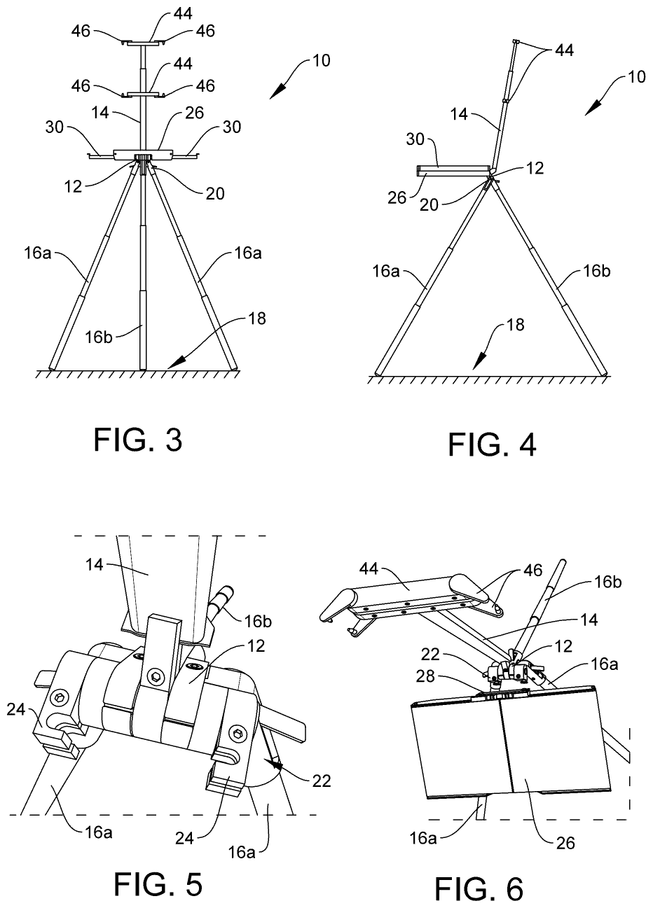

Provided in FIG. 1 is a perspective view of an embodiment of an artist's support structure 10 in accordance with the present disclosure in its unfolded operational configuration. The same device in its folded transport or storage configuration is shown in FIG. 2, and orthogonal front and side views of the same are provided in FIGS. 3 and 4. The multi-function artist's support device 10 disclosed herein generally includes a base 12, with a support arm 14 pivotally attached to and upwardly extending from the base 12, and a group of telescoping legs 16, downwardly extending from the base 12. In the embodiments depicted herein the artist's support device 10 has three legs 16, but it will be apparent that more than three legs can be associated with this sort of device.

As shown in FIG. 2, the legs 16 have a folded or closed position, in which they are generally parallel and proximal to each other. The view of FIG. 2 shows the legs 16 in their linearly retracted condition, but it is to be appreciated that the legs 16 can be folded together when they are retracted or extended to any length. FIGS. 1, 3 and 4 show the legs 16 in an unfolded position, in which they are angularly spread apart for supporting the base 12 above a surface 18, such as the ground or a floor surface. This is the operational position of the artist's support 10 disclosed herein.

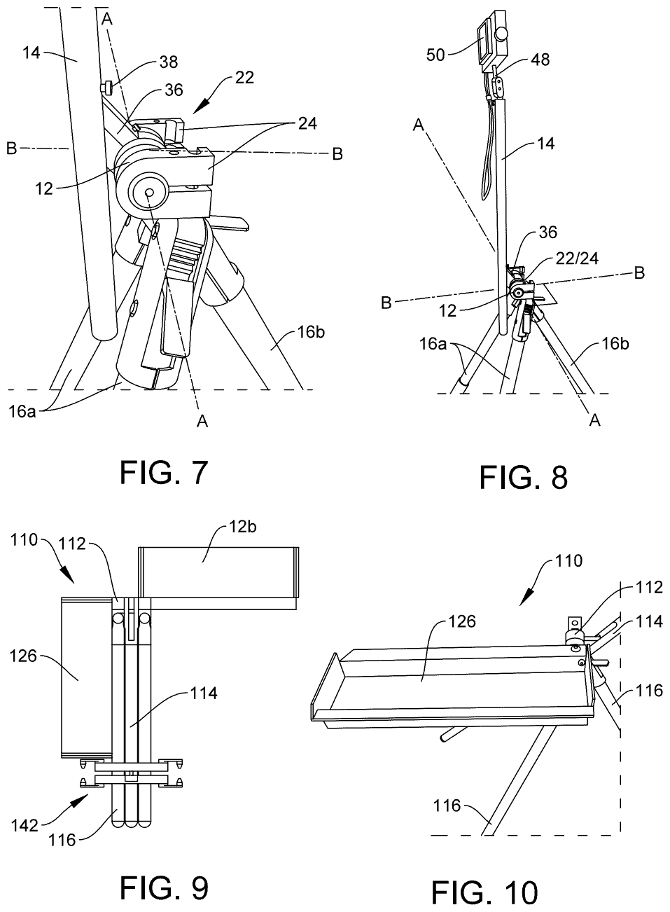

The arrangement of the legs 16 when in the operational position is shown most clearly with reference to FIGS. 1 and 3-8. When the legs 16 are extended for use, the two outer legs 16a are positioned forwardly, while the third leg 16b extends rearwardly. The upper end 20 of each of the legs 16 are pivotally connected to the base 12. As best illustrated in FIGS. 7 and 8, the two outer or forward legs 16a are oriented to rotate in a first common plane, designated by axis A-A, while the center or rear leg 16b is configured to rotate in a second plane, designated by axis B-B, which is perpendicular to axis A-A. Thus, the outer legs 16a will rotate about axes that are parallel to axis B-B, while the rear leg 16b rotates about an axis that is parallel to axis A-A, so that the outer or forward legs 16a rotate in a first plane that includes axis A-A, while the center or rear leg 16b rotates in a second plane that is perpendicular to the first plane and includes axis B-B. This arrangement of the outer legs 16a and center leg 16b are also shown in the view of FIG. 2, which shows the legs folded and parallel to each other. It is to be appreciated that this geometrical arrangement of the legs 16 is only one of many possible configurations for legs for an artist's support structure in accordance with the present disclosure.

Advantageously, this device 10 generally and the base 12 in particular include a number of desirable features. Shown in FIG. 5 is a close-up top view of one embodiment of the base 12 of the artist's support structure 10 of FIG. 1. In this embodiment the base 12 includes a multi-purpose adapter, indicated generally at 22, having a pair of lateral hooks 24, specially configured for releasably receiving and mechanically securing a variety of useful artist's devices. For example, as shown in FIG. 6, an artist's box 26 can be removably attached to the base 12 via the hooks 24 and the top horizontal surface of the hooks. This box easel setup is similar in some ways to that described in U.S. Pat. No. 6,308,925, the disclosure of which is incorporated herein by reference in its entirety. This particular artist's box 26 has a back face 28 with a mount that fits into the lateral hooks 24 of the base 12, and has top lids 30 that open laterally to provide a working surface for the user. This type of artist's box is shown opened for use in FIGS. 1 and 3. In FIG. 3 the lids 30 of the box are shown folded outward for use, and in FIG. 1 various artist's supplies, including a palette 32, brushes 34 and the like, which can be conveniently stored within the box 26 when not in use, are shown conveniently positioned on the working surface for use by the artist.

The support arm 14 is pivotally attached to the base 12. In the view of FIG. 2 the support arm 14 is folded parallel to the legs 16. However, for use, the support arm 14 is rotated away from the legs 16, extending generally oppositely from the legs. A close-up, side view of the base 12 and support arm 14 are shown in FIG. 7. The support arm 14 is attached to the base 12 via a pivoting mount 36. In the embodiment shown in FIGS. 7 and 8, the support arm 14 is slidingly attached to the pivoting mount. A set screw 38 can be provided to allow the position of the support arm 14 to be secured at the desired position. This configuration is considered useful for the camera mount embodiment. Alternatively, the support arm 14 can be fixedly connected to its pivoting mount 36, and this embodiment may be considered desirable for the easel configuration shown in FIGS. 1-6. The height of the support arm 14 can thus be adjusted to any desired position, and the pivoting mount 36 allows a canvas (40 in FIG. 1) or other item to be held at any desired angle, using adjustable friction devices (not shown).

The support arm 14 can be used in a variety of ways. As shown in FIGS. 2-6, easel supports, indicated generally at 42, can be attached to the support arm 14. The easel supports 42 generally include a pair of crossbars 44, slidably attached to the support arm 14, each crossbar 44 having a pair of pivoting canvas support hooks 46 disposed at opposing lateral ends. Advantageously, the crossbars 44 shown are configured so that the painting (40 in FIG. 1) completely covers them, so that no paint gets on the crossbars 44, reducing the need for cleaning. Additionally, the painting holders or hooks 46 can have a cone-shape or be angled wire or rod, so that they also get less paint on them, which eases cleaning.

FIG. 1 shows a canvas 40 supported by the hooks 46 of the easel supports 42. The easel supports 42 are adjustable upon the support arm 40 in order to accommodate various sizes of canvas (or other painting surface). Additionally, the hooks 46 can be rotatable upon their respective crossbars 44, so that a user can mount them on the opposite side of the support arm 14, if it desired to work without an artist's box (26 in FIGS. 1, 3-4, 6) or any other structure between the user and the canvas. It is to be appreciated that the term “canvas” as used herein is intended to generally refer to any surface on which an artist may work, whether actual canvas or other material, such as paper, hardboard, etc.

The support arm 14 can also be configured in other ways. For example, as shown in FIG. 8, the support arm 14 can be provided with a removable camera mount 48, which can support a camera 50. Thus, an artist can use the support structure 10 specifically for photography, or keep a camera mount 48 and camera 50 with their other artist tools and supplies, so that the support structure 10 can be quickly converted for photography when it is desired, for example, to capture a particular scene or lighting condition for later reference.

Another embodiment of an artist's support structure 110 in accordance with the present disclosure is shown in FIGS. 9 and 10. This embodiment is a one-piece tripod and artist's box, similar that described in U.S. Pat. No. 6,308,925. In this embodiment, a pair of artist's trays 126 are hingedly attached to the base 112. In the folded configuration, shown in FIG. 9, the trays 126 can be positioned parallel to the folded legs 116, as shown on the left-hand side of this figure. For use, however, the artists's trays 126 can be rotated outward, as indicated on the right-hand side of FIG. 9, so that they are conveniently positioned for use when the combination easel 110 is opened and the easel support 142 configured for use, as shown in FIG. 10. It will be apparent that FIG. 9 shows a support structure 110 with two attached boxes or trays 126, while FIG. 10 shows the same general configuration, but with only one attached tray 126. In FIG. 10 the extended legs 116 and upper support arm 114 are clearly seen in relation to the base and the artist's tray 126.

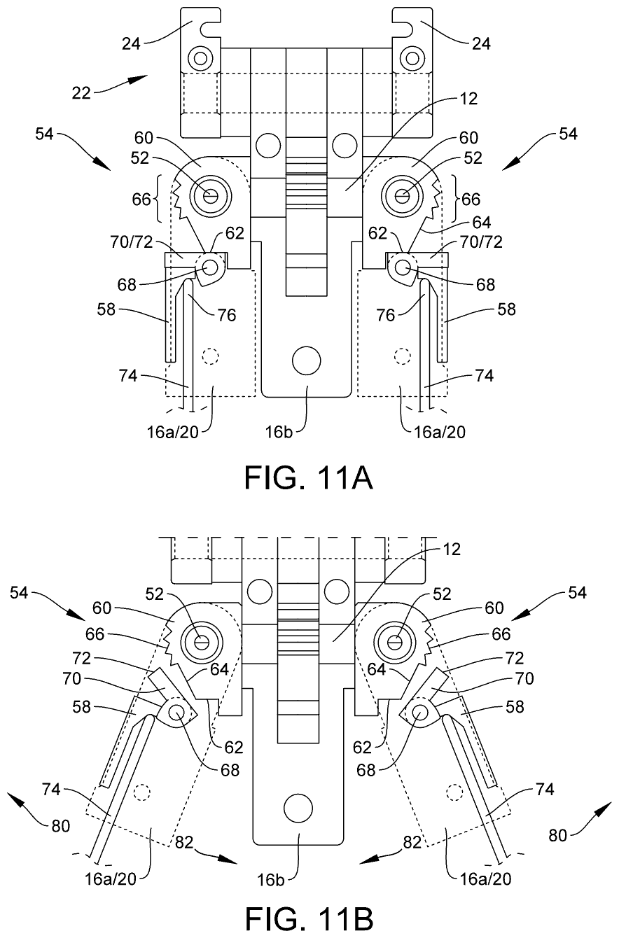

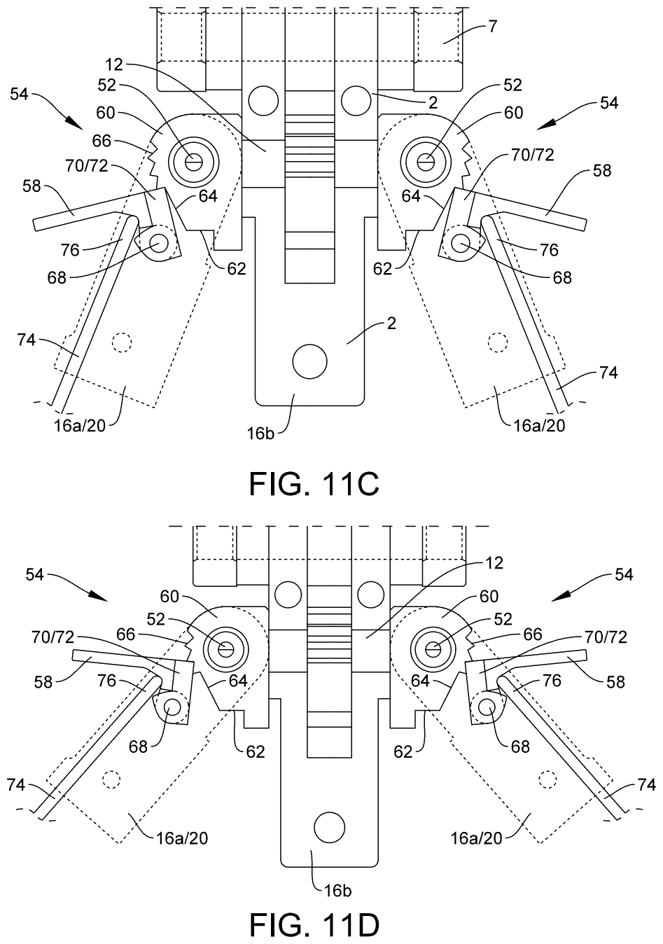

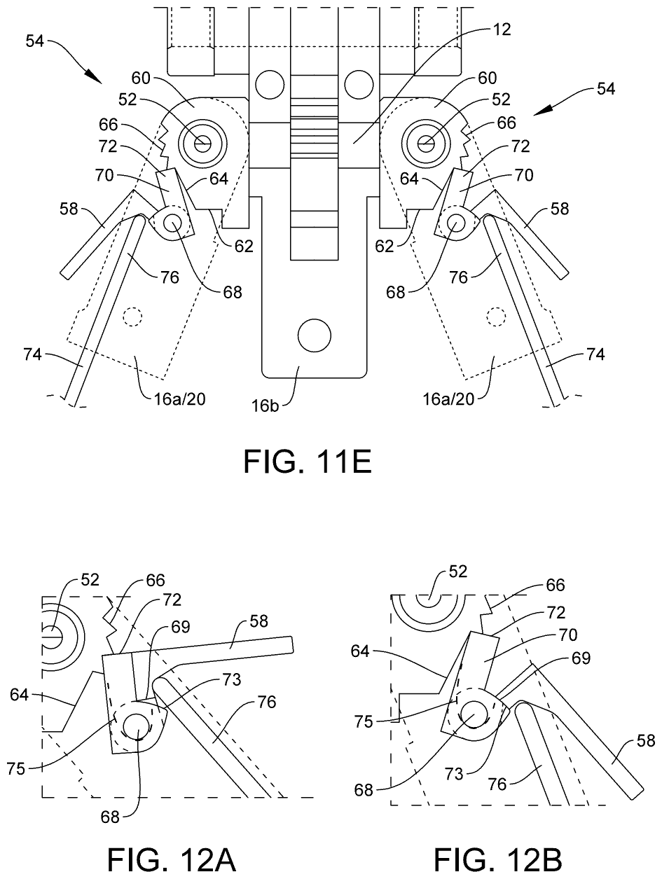

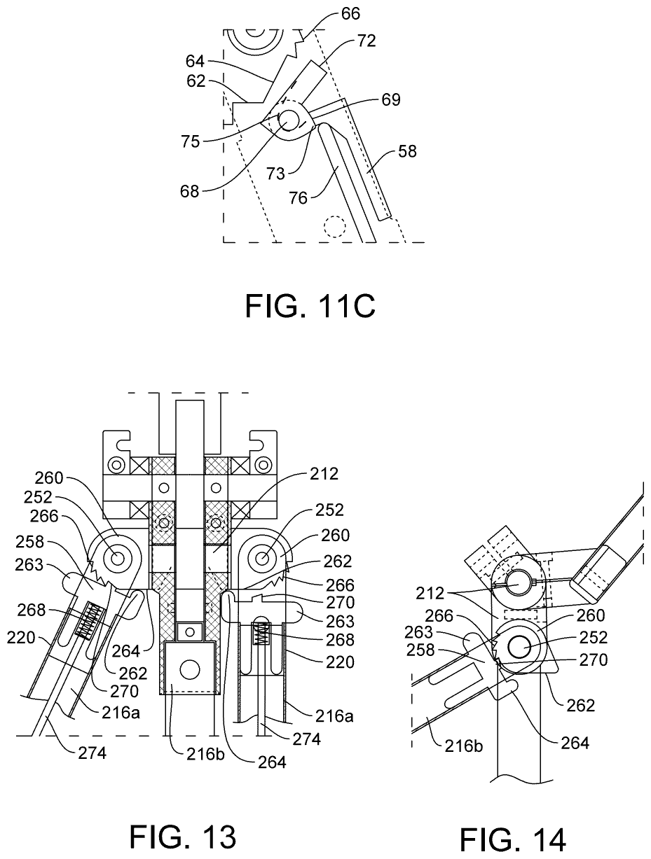

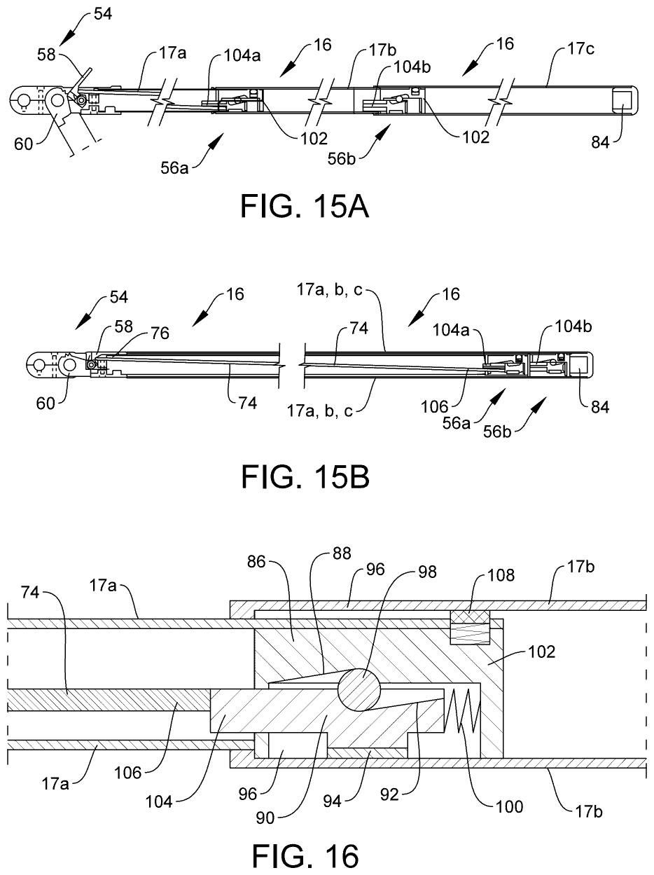

Advantageously, the artist's support device disclosed herein incorporates a multi-function release mechanism, which can control both the angular and linear extension and retraction of the legs. The features and operation of this release mechanism are shown most clearly in the views of FIGS. 11A-11E, where it can be seen that the top end 20 of each leg 16 is pivotally connected to the base 12 via a pivot shaft 52. The multi-function release mechanism generally includes a ratchet mechanism, indicated generally at 54, one or more one-way cam lock devices disposed in each leg and indicated generally at 56 in FIGS. 14A-B and FIG. 15, and a release actuator, such as the release lever 58, clearly visible in FIGS. 5-8, 11A-11E and 14A-B. The release actuator or release lever 58 is coupled to the ratchet mechanism 54 and the internal cam lock devices 56 of each leg, so that it can control operation of both.

The ratchet mechanism 54 is most clearly shown in FIGS. 11A-11E, and generally includes a ratchet gear 60, fixedly attached to the base 12 and concentric with the pivot shaft 52 of the respective leg 16. The following discussion of the structure and operation of the ratchet mechanism 54 is presented with respect to the outer legs 16a shown in FIGS. 11A-11E, but it is to be appreciated that the same structure and functions apply equally to the center leg 16c, though at a perpendicular angle. The ratchet gear 60 includes a release shoulder 62 at its lower end, and a release ramp 64 that extends between the release shoulder 62 and the gear teeth 66.

The release lever 58 in this embodiment is generally L-shaped, and is pivotally attached to the respective leg upon a release pivot 68, positioned in the upper section of the leg 16. Detailed views of the structure and operation of the release lever 58 and associated structure are shown in FIGS. 12A-C. As best shown in FIG. 12A, the release lever 58 includes an outer shoulder 69. A pawl 70 is also pivotally attached upon the release pivot 68. The pawl 70 has an engagement end 72 that is configured to engage the teeth 66 of the ratchet gear 60, and a release shoulder 73 that is positioned near the outer shoulder 69 of the release lever 58. The pawl 70 is spring-biased toward engagement of the pawl 70 with the teeth 66 of the ratchet gear via a leaf spring 75, which is disposed within/between the release lever 58 and pawl 70. A release rod 74 is disposed within the upper tube of the respective leg 16, the upper end 76 of the release rod 74 positioned in sliding contact with the release lever 58 in the crook of the L-shaped structure. The release rod 74 is upwardly biased by a spring in the associated cam lock mechanism (56 in FIGS. 15A-B), and therefore naturally pushes the release lever toward the release position. Operation of the release rod 74 is described in more detail below.

The release lever 58 has three primary positions: fully open, as shown in FIGS. 11C-D and 12A, partially closed, as shown in FIGS. 11E and 12B, and fully closed, as shown in FIGS. 11A-B and 12C. When the release lever 58 is fully open and the leg 16 is unfolded in the direction of arrows 78, as shown in FIGS. 11C-D, the engagement end 72 of the spring-biased pawl 70 will naturally tend to catch the first possible tooth 66 of the ratchet gear 60. During this operation, if the release lever 58 is not quite fully open, the pawl 70 can slide along the release ramp 64 of the ratchet gear 60 until it reaches the position of the first tooth 66. When the ratchet mechanism 54 is engaged in this way, the angular extension of the legs 16 will be governed by the location of the particular tooth 66 position where the pawl 70 is engaged, and further extension will be prevented, thus fixing or locking the angular position of the leg 16 against further angular extension, for solid support of the tripod. Different leg angle lock positions are shown in FIGS. 11C-D.

As best seen in FIG. 12A, the outer shoulder 69 of the release lever 58 and the release shoulder 73 or the pawl are angularly separated from each other when the release lever and pawl are positioned as shown in this figure. When the release lever 58 is rotated to the partially closed position, as shown in FIGS. 11E and 12B, the outer shoulder 69 of the release lever 58 can draw toward and contact the release shoulder 73 of the pawl 70 without rotating the pawl, leaving the pawl 70 in engagement with the ratchet gear 60 under the force of the leaf spring.

However, when the release lever 58 is rotated to the fully closed position, as shown in FIGS. 11B and 12C, the outer shoulder 69 of the release lever 58 will engage the release shoulder 73 of the pawl 70, rotating and withdrawing the pawl 70 from engagement with the ratchet gear 60. This will allow the user to rotate the leg 16 further in the direction of arrow 80 to a further angularly extended position if desired, where, if the release lever 58 is then released, the pawl 70 will naturally engage at another position on the ratchet gear 60 under the force of the leaf spring 75. Advantageously, it is to be appreciated that because the ratchet mechanism 54 is a one-way ratchet mechanism, whether the release lever 58 is closed or open, that is, released or not, the user can rotate the leg 16 to the folded position, as shown in FIG. 11A, at any time. If a user rotates the leg 16 toward the folded position when the pawl 70 is engaged with the ratchet gear 60, because of the relative positions of the engagement end 72 of the pawl and its pivot point (release pivot 68), the pawl 70 can slide over the teeth 66 of the ratchet gear 60 during this motion, merely “clicking” into each tooth gap as it passes over, under the force of the leaf spring 75. This sort of operation of a one-way ratchet mechanism is well known. When rotated to the folded position, the shoulder 62 of the ratchet gear 60 will contact the top of the release lever 58 and the pawl 70, holding both in the fully released position. In this way the one-way ratchet mechanism 54 can lock a selected rotational angle of the leg 16 against angular extension, while allowing free angular folding of the legs 16 in any configuration.

Between the fully closed position shown in FIGS. 11A-B and 12C and the fully open position shown in FIGS. 11C-D and 12A, the release lever 58 has an intermediate release position, shown in FIGS. 11E and 12B. In this position, the partially rotated release lever 58 pushes on the top of the release rod 74, while the pawl 70, under the force of the leaf spring 75, is still engaged with the ratchet gear 60. The release rod 74 controls release of the cam lock devices (56 in FIGS. 15A-B and 16) of the tubular legs 16, thus allowing the release mechanism in this position to allow telescoping linear retraction of the legs 16 without affecting the angular position of the legs 16 (which is governed by the ratchet mechanism 54).

Operation of the release rod 74 and the cam lock devices 56 are illustrated more fully with reference to FIGS. 15A-B and FIG. 16. Each leg 16 comprises a plurality of telescoping tubes, adjacent tubes being interconnected via an internal one-way cam lock device, indicated generally at 56. These cam lock devices 56 are similar to those disclosed in U.S. Pat. No. 7,967,261, the disclosure of which is incorporated by reference herein in its entirety. In the views of FIGS. 14A and 14B the top of the leg 16 is to the left and the bottom of the leg 16 is to the right, with a resilient foot pad 84 at the very bottom. In this embodiment, the larger diameter leg tubes are toward the bottom, and the smaller diameter tubes are toward the top of the leg 16. This arrangement has the benefit that dirt and debris on the bottom section of the leg 16 cannot be drawn into and affect the cam lock mechanisms 56.

Each telescoping leg 16 has at least two telescoping sections, though more than two sections can be used. In FIGS. 15A-B, the telescoping legs 16 each include three telescoping sections 17a, 17b and 17c, with two interconnecting cam lock devices 56 each, designated 56a and 56b, respectively. In each case, a given cam lock device 56 will relate to an upper telescoping section and a lower telescoping section, respectively, and allows the telescoping tubes to extended or retracted, allowing the length of each leg 16 to be adjusted.

Each cam lock device 56 includes a ramp block 86, having a first ramp surface 88, fixedly attached within the first or smaller (i.e. upper) tube section 17a of the leg 16. Slidingly positioned opposite the ramp block within the first tube section 17a is a slide block 90, having a second ramp surface 92 positioned opposite the first ramp surface 88. The slide block 90 has a gripping surface 94 extending outwardly against an inner wall 96 of the second or outer tube section 17b (which is disposed around the first tube section 17a). A portion of the inner tube section 17a is cut away in the region of the slide block 90, allowing the gripping surface 94 to extend through the corresponding opening to contact the inner wall 96. A roller 98 is disposed between the first and second ramp surfaces 88, 92, and a biasing spring 100 is disposed between the distal end of the slide block 90 and an end shoulder 102 of the ramp block 86. The proximal end of the slide block 90 includes a release extension 104, which is in contact with or connected to the lower end 106 of the release rod 74. The ramp block 86 also includes a friction pad 108, which extends through an opening in the wall of the upper tube section 17a and presses against the inside of the wall of the lower or outer tube section 17b. This pad 84 provides friction that helps keep the legs 16 from extending when the support device 10 is in storage and the legs 16 are extended to a position shorter than their full length (i.e. the legs 16 are parallel and retracted to less than their maximum length).

With this configuration, the force of the biasing spring 100 naturally causes or maintains linear displacement of the slide block 90 in a first direction, indicated by arrow 105, relative to the ramp block 86, causing the roller 98 to advance between the ramp surfaces 88, 92 and push the ramp block 86 and slide block 90 apart, thus pressing the gripping surface 94 against the inside wall 96 of the second tube and resisting sliding relative motion of the first and second tubes. However, when the release rod 74 is pushed, this causes linear displacement of the slide block 90 relative to the ramp block 86 in a second direction, indicated by arrow 107, compressing the biasing spring 100 and causing the roller 98 to retract between the first and second ramp surfaces 88, 92. This allows the ramp block 86 and slide block 90 to draw together, releasing pressure of the gripping surface 94 (and the friction pad 108) against the inside surface 96 of the second tube, allowing sliding relative motion thereof.

At the same time, when the cam lock device 56 is engaged, an extending force applied to the second or outer tube will naturally release the cam lock device 56, allowing free extension. Specifically, when the cam lock device 56 is locked, friction of the gripping surface 94 against the inner surface 96 of the outer tube holds it in place. However, if that outer tube is pulled by the application of an extending force, the friction between that outer tube and the gripping surface 96 will have the same effect as pushing of the release rod 74. That is, friction will linearly push the slide block 90 relative to the ramp block 86 in the direction, of arrow 107, compressing the biasing spring 100 and causing the roller 98 to retract and allow the ramp block 86 and slide block 90 to draw together, releasing pressure of the gripping surface 94 (and friction pad 108) against the inside surface 96 of the second tube and allowing sliding relative motion thereof. In this way the upper and lower tube sections are normally locked against compression of the leg 16 (when not specifically released), while being freely slidingly extendable, making this a one-way cam lock device.

Viewing FIG. 14B it will be apparent that the second cam lock device 56b in this three-tube telescoping leg 16 is not in contact with the release rod 74. However, the second cam lock device 56b also includes a release extension 104. When the first cam lock device 56a is released and the associated lower or outer tube is fully retracted over it, the release extension 104 of the second cam lock device 56b will contact the distal end 102 of the ramp block 86 of the first cam lock device 56a, thus pushing the second slide block 90 against its respective biasing spring 100 and allowing it to release in the same manner as the first. In this way, full retraction of a corresponding tube section causes contact with and sequential release of a second or subsequent cam lock device 56 and retraction of a corresponding second tube section.

The release mechanism thus has a first or partial release position, shown in FIG. 11E, wherein the release rod 74 is pushed downwardly and the cam lock devices 56 are released while the ratchet mechanism 54 is unaffected, thereby allowing only linear retraction of the legs 16, and a second or fully released position, shown in FIGS. 11A-B, wherein both the cam lock devices 56 and the ratchet mechanism 54 are released, allowing both linear and angular retraction of the legs 16. Thus, when the legs 16 are rotated to the folded position shown in FIG. 11A, contact of the ratchet shoulder 62 holds the release lever 58 down, with the release rod 74 in the extended position, and thereby releases the cam lock devices 56 of all legs 16, so that the one-way cam locks allow the legs 16 to be linearly extended or retracted. Indeed, the one-way function of the cam lock devices 56 allows the legs 16 to be freely extended at any time merely by grabbing them and pulling.

It is to be understood that the release lever 58 shown in FIGS. 5-8, 11A-11E and 15A-B represents one of various possible embodiments of a release actuator that can be used in accordance with the present disclosure. Other configurations are also possible. For example, as shown in FIGS. 13 and 14, the release actuator can be a slide 258, rather than a lever. The view of FIG. 13 shows this configuration for the front legs 216a of the tripod, while FIG. 14 shows the same for the rear leg 216b of an artist's support structure like that shown in FIGS. 1-10. Like the embodiment discussed above, the upper end 220 of each leg 216 is pivotally connected to the base 212 via a pivot shaft 252, with a ratchet gear 260 concentrically affixed to the base 212 around the pivot shaft 252. The ratchet gear 260 includes teeth 266 and a lower shoulder 262.

In this configuration, the release actuator is a slide 258, which is linearly moveable within the top end 220 of each leg 216, and biased upward by a biasing member or spring 268. The slide 258 has an actuation nub 263 on one end, a release extension 264 disposed on the opposing lateral end of the slide, opposite the nub 263, and an upwardly extending integral pawl 270 disposed between the actuation nub 263 and the release extension 264. The actuation nub 263 is configured for manual operation of the slide 258 by a user. The lower end of the slide 258 is connected to the upper end 276 of the release rod 274, which is connected at its opposite end to the cam lock device (not shown in FIGS. 13, 14) of the tubular leg 16, in the manner discussed above.

The biasing member 268 of the slide 258 is connected between the slide and the leg 216, and is configured to bias the slide 258 toward an engaged position in which the integral pawl 270 is engaged with the teeth 266 of the ratchet gear 260. A condition in which the leg 216 is angularly extended and the pawl 270 engaged with the ratchet gear 260 is shown on the left-hand side of FIG. 12. When a user retracts the slide 258 (downwardly in the figure), the pawl 270 is released from the ratchet gear 260, allowing angular rotation of the leg 216, while the release rod 274 is simultaneously pushed downward to release the cam lock devices (not shown in FIGS. 13, 14) of the leg 216. The release extension 264 is positioned so that, when the leg 216 is in the folded position, as shown on the right-hand side of FIG. 12, the release extension 264 contacts the shoulder 262 of the ratchet gear 260, and thus is held in the released position, pushing down on the release rod 274 and holding the pawl 270 in its withdrawn position. As with the release lever embodiment discussed above, the sliding release mechanism of FIGS. 13-14 has the same ability to first release the leg-locking mechanism to allow length change of the legs 216, and then, with further travel, the angle-stop pawl.

Advantageously, the integral pawl 270 is angled for one-way engagement with the teeth 266 of the ratchet gear 260. This feature is apparent on the left-hand side of FIG. 12. The angle of the upper surface of the pawl 270 is such that the pawl can slide over the teeth 266 of the ratchet gear when the leg 216 is rotated in the folding direction. The biasing force of the spring 268 will hold the pawl 270 against the teeth 266 as it slides, producing a click-click-click sound that is typical of ratchet devices, but will allow the leg 216 to be freely rotated toward the folded position without manipulation of the slide 258. At the same time, the angle of the pawl 270 and of the teeth 270 will prevent rotation in the opposite direction without release of the slide 258.

The invention thus provides an easel/tripod that is strong, lightweight, simpler to use and more versatile than many other similar devices. It provides three different products in one: a combination artist's easel, box easel and photo tripod, with the ability to attach other devices. It offers great versatility, ease and speed of setup and takedown in an extremely compact package. It can store artist's supplies, provide a working table with palette and hold a canvas or other substrate at multiple angles. Advantageously, both box and post angles can be changed simply by rotating them on the hub. The flat side-by-side legs and small cross-section post allow a package that is about ⅓ the cross-section of a tripod with similar diameter legs and a central post.

By virtue of the one-way cam lock configuration, the side-by-side grouped legs can all be extended at once with one motion and with no releases needed. Moving the legs from the parallel position to the desired angle of use automatically deploys the release actuator in each leg 16. On the other hand, folding all the legs back to the folded position automatically releases the legs for telescoping retraction. The release actuators thus have dual function and are easy to use, even with gloved or weak hands. On the other hand, when the legs are folded to their parallel storage position, the release levers 58 are automatically retracted, releasing the leg locking mechanisms, making it possible to just push down on the easel or tripod to shorten all sections to their stored length or any other shorter length in one motion through automatic sequential release of the cam-lock devices. Additionally, the dual-function release actuators are at the top of the device, rather than the bottom or at each joint in the legs, so that each section can be adjusted with a touch of just one lever. This also helps make the bottom of the legs resistant to water and sand.

It is to be understood that the above-referenced arrangements are only illustrative of the application of the principles of the present invention in one or more particular applications. Numerous modifications and alternative arrangements in form, usage and details of implementation can be devised without the exercise of inventive faculty, and without departing from the principles, concepts, and scope of the invention as disclosed herein. Accordingly, it is not intended that the invention be limited, except as by claims.

What is claimed is:

1. A combination box easel and camera support, comprising:
a base, having a multi-purpose adapter, configured to receive and mechanically secure an artist's device;
a support arm, pivotally attached to and upwardly extending from the base;
a group of legs, pivotally connected to and downwardly extending from the base, having a folded position, in which the legs are generally parallel and proximal to each other, and an unfolded position in which the legs are angularly spread apart, each leg comprising a plurality of telescoping tubes connected via an internal one-way cam lock device; and
a release mechanism, disposed at an upper end of each leg, configured to selectively (a) release the cam lock device to allow sliding linear retraction of the respective leg, and (b) allow angular extension of the respective leg.

2. A combination box easel and camera support in accordance with claim 1, wherein the release mechanism is configured to release the cam lock devices of all legs when the legs are rotated to the folded position.

3. A combination box easel and camera support in accordance with claim 1, further comprising:
a one-way ratchet mechanism, interconnected between the base and a top end of each leg, configured to selectively lock a rotational angle of the leg against angular extension; and
a release actuator, disposed upon each leg, mechanically engaged with the cam lock device and the ratchet mechanism of the respective leg, the release actuator having a partial release position in which only the cam lock device is released, and a full release position in which both the cam lock device and the ratchet mechanism are released.

4. A combination box easel and camera support in accordance with claim 3, wherein the release actuator comprises a release lever, and further comprising:
the one-way ratchet mechanism including a ratchet gear, having teeth, fixedly attached to the base and concentrically oriented with respect to a pivot point of the top end of the respective leg;
a spring biased pawl, pivotally attached to the release lever, configured for engagement with the teeth of the ratchet gear; and
a release rod, disposed within an upper tube of the respective leg, having an upper end in contact with the release lever, and a lower end in contact with the cam lock device, rotation of the release lever to the partial release position pushing the release rod against and releasing the cam lock device, and rotation of the release lever to the full release position simultaneously (a) pushing the release rod against and releasing the cam lock device and (b) disengaging the pawl from the teeth of the ratchet gear.

5. A combination box easel and camera support in accordance with claim 1, wherein each leg comprises more than two telescoping tube sections, with a one-way cam lock device interconnected between adjacent tube sections, release of a first cam lock device and full retraction of a corresponding tube section causing contact with and sequential release of a second cam lock device and retraction of a corresponding second tube section.

6. A combination box easel and camera support in accordance with claim 5, wherein the release mechanism is configured to sequentially release all cam lock devices of a respective leg whenever the respective leg is rotated to the folded position.

7. A combination box easel and camera support in accordance with claim 3, wherein the release actuator comprises:
a slide, linearly moveable within the top end of each leg, the slide having
an upwardly extending integral pawl, angled for one-way engagement with the teeth of the ratchet gear;
an release extension, disposed on an inward lateral side of the slide;
a lower portion of the slide connected to an upper end of the release rod; and
a biasing member, connected between the slide and the leg, configured to bias the slide toward an engaged position in which the integral pawl is engaged with the teeth of the ratchet gear, the release extension positioned to contact a lower portion of the base and push the slide to a released position when the leg is in the folded position.

8. A combination box easel and camera support in accordance with claim 1, wherein the group of legs comprises three legs.

9. A combination box easel and camera support in accordance with claim 7, wherein the three legs comprise two outer legs, oriented to rotate in a first common plane, and a rear leg, configured to rotate in a second plane that is perpendicular to the first common plane.

10. A combination box easel and camera support in accordance with claim 1, wherein the cam lock device comprises:
a ramp block, having a first ramp surface, fixedly attached within a first tube section of the leg;
a slide block, slidingly positioned opposite the ramp block within the first tube section and having a second ramp surface positioned opposite the first ramp surface, the slide block having a gripping surface extending outwardly against an inner wall of a second tube section disposed around the first tube section; and
a roller, disposed between the first and second ramp surfaces, linear displacement of the slide block relative to the ramp block in a first direction causing the roller to advance and push the first and slide blocks apart, pressing the gripping surface against the second tube and resisting sliding relative motion against the second tube, linear displacement of the slide block relative to the ramp block in a second direction causing the roller to retract and allow the first and slide blocks to draw together, releasing pressure of the gripping surface against the second tube and allowing sliding relative motion thereof.

11. An artist's support, comprising
a base;
a support arm, pivotally attached to and upwardly extending from the base;
a plurality of telescoping tubular legs, downwardly extending from the base;
a one-way ratchet mechanism, pivotally interconnecting a top of each leg to the base, configured to allow angular folding and resist angular extension of the respective leg;
a one-way cam lock device, disposed within each tubular leg, configured to allow free sliding linear extension and resist linear compression of the respective leg; and
a multi-function release mechanism, associated with each leg, having a biased release actuator, coupled to the ratchet mechanism and the internal cam lock device, the release actuator having
a first release position that releases the cam lock device, allowing telescoping linear retraction of the leg without affecting the ratchet mechanism; and
a second release position that releases both the cam lock device and the ratchet mechanism, allowing linear and angular retraction of the leg.

12. An artist's support in accordance with claim 11, wherein the release actuator comprises a release lever, the one-way ratchet mechanism further comprising:
a ratchet gear, having teeth, fixedly attached to the base; and
the release mechanism further comprising:
a pawl, pivotally connected to the release lever, configured to selectively engage the teeth of the ratchet gear, movement of the release lever to the second position withdrawing the pawl from the teeth; and
a release rod, positioned adjacent to the release lever and extending to a release extension of the cam lock device, movement of the release lever to the first and second positions pushing the release rod against the release extension to release the cam lock device.

13. An artist's support in accordance with claim 11, wherein
the telescoping legs have a closed position, in which the legs are generally parallel and proximal to each other, and an unfolded position in which the legs are spread apart for supporting the base above a surface; and wherein
folding the legs to the closed position mechanically actuates the release actuator of each leg to the second position.

14. An artist's support in accordance with claim 11, wherein the base includes a multi-purpose adapter, configured to receive and mechanically secure an artist's device.

15. An artist's support in accordance with claim 11, further comprising a camera mount, removably attachable to the support arm.

16. A combination box easel and camera tripod, comprising:
a base;
a support arm, pivotally attached to and upwardly extending from the base;
three telescoping legs, each leg pivotally connected to the base on a pivot shaft and extending downward therefrom, each telescoping leg having upper and lower telescoping sections;
a one-way cam-lock device, interconnecting the upper and lower telescoping sections of each leg, having a first condition in which the upper and lower sections are locked against compression of the leg while being freely slidingly extendable, and a released condition, allowing both sliding extension and retraction of the leg;
a one-way ratchet mechanism, interconnected between the base and a top end of each leg, configured to selectively lock a rotational angle of the leg against angular extension while allowing selective folding angular retraction of the leg; and
a release actuator, disposed upon each leg, mechanically engaged with the cam lock device and the ratchet mechanism of the respective leg, the release actuator having a partial release position in which only the cam lock device is released, and a full release position in which both the cam lock device and the ratchet mechanism are released.

17. A combination box easel and camera tripod in accordance with claim 16, wherein the release actuator comprises a release lever, the one-way ratchet mechanism further comprising:
a ratchet gear with teeth, concentrically disposed around the pivot shaft of each leg;
a release pivot, affixed in the upper section of each leg, the release lever being pivotally attached upon the release pivot;
a spring-biased pawl, pivotally attached upon the release pivot, having a release shoulder, and an engagement end biased toward engagement of the teeth of the ratchet gear; and
further comprising
the release lever having an outer shoulder disposed against the release shoulder of the pawl; and
a release rod, disposed within the upper section of each leg, having an upper end in engagement with the release lever, and a lower end in engagement with the upper release end of the cam lock device, partial rotation of the release lever in a release direction being effective to push the release rod against and release the cam lock device, allowing telescoping retraction of the upper leg section into the lower leg section, and full rotation of the release lever in the release direction simultaneously releasing the cam lock device and disengaging the pawl from the ratchet gear, allowing the leg to be selectively rotated toward a folded position.

18. A combination box easel and camera tripod in accordance with claim 16, wherein:
the legs have a folded position, in which all legs are generally parallel and proximal to each other, and an unfolded position in which the legs are angularly spread apart; and
wherein
the release actuator is coupled to release the cam lock devices of all legs when the legs are rotated to the folded position.

19. A combination box easel and camera tripod in accordance with claim 16, wherein each leg comprises more than two telescoping tube sections, with a one-way cam lock device interconnected between adjacent tube sections, release of a first cam lock device and full retraction of a corresponding tube section causing contact with and sequential release of a second cam lock device and retraction of a corresponding second tube section.

20. A combination box easel and camera tripod in accordance with claim 16, wherein the base comprises a multi-purpose adapter, the base and upright support being configured to receive and mechanically secure an artist's device selected from the group consisting of an artist's box, an easel, and a camera.
